(19) United States
(12) Patent Application Publication
(10) Pub. No.: US 2012/0146258 A1
(43) Pub. Date: Jun. 14, 2012

(54) Method of Making Crystals From Remains

(76) Inventors: Ok Pyung Kim, Seoul (KR); Hyun Taek Jeong, Chungcheongnam-do (KR)

(21) Appl. No.: 12/965,751

(22) Filed: Dec. 10, 2010

(51) Int. Cl. B29C 39/02; B02C 19/00

(52) U.S. Cl. 264/319; 241/25

(57) ABSTRACT

A method of making crystals from remains, including the steps of: recovering remains; pulverizing the remains to form bone powder having a particle size of 0.05 mm or less; mixing the bone powder with a natural mineral to form spherical seeds; putting the spherical seeds into a calcinator and then leaving them at a temperature of 900˜950° C. for 10˜20 minutes to form solid crystals; and cooling and then surface-treating the solid crystals. The method is advantageous in that the time and cost for forming crystals can be reduced by mixing bone powder with a natural mineral and then calcinating the mixture at lower temperature to form solid crystals. Further, the crystals formed using the method are advantageous in that they are easily stored and moved, and can contribute to the preservation of the natural environment and the improvement of funeral services, in that they can be kept in a sanitary manner compared to when the remains are kept in a cinerary urn in an unsanitary manner, and in that they can be efficiently used in terms of space utilization.

### BACKGROUND OF THE INVENTION

1. Technical Field

The present invention relates to a method of making crystals from the remains, and, more particularly, to a method of making crystals from the remains existing after cremating the body.

2. Description of the Related Art

Conventionally, methods of keeping the remains existing after the cremation of the body by storing them in a cinerary urn have been used. However, the cinerary urn is problematic in that it is difficult to manage thereafter and in that the remains are easily damaged by moisture or the like.

Recently, methods of making crystals from the remains existing after the cremation of the body and then keeping the crystals have been used. As such, when the remains are changed into crystals, there are advantages in that bone powder does not scatter and in that the crystals of these remains are easily preserved and do not visually show a feeling of rejection.

However, in most conventional methods of crystallizing the remains, crystals are formed by melting bone powder at a high temperature of 1200° C. or more. Therefore, these conventional methods are problematic in that processing costs increase because the remains must be heated for a long period of time at high temperature, and in that processing time becomes long.

### SUMMARY OF THE INVENTION

Accordingly, the present invention has been devised to solve the above-mentioned problems, and an object of the present invention is to provide a method of making crystal from the remains, which can reduce the time and cost for forming crystals by mixing bone powder with a natural mineral and then calcinating the mixture at lower temperature to form solid crystals.

In order to accomplish the above object, an aspect of the present invention provides a method of making crystals from remains, including the steps of: recovering remains; pulverizing the remains to form bone powder having a particle size of 0.05 mm or less; mixing the bone powder with a natural mineral to form spherical seeds; putting the spherical seeds into a calcinator and then leaving them at a temperature of 900˜950° C. for 10˜20 minutes to form solid crystals; and cooling and then surface-treating the solid crystals.

Here, the natural mineral may include at least one selected from lithium (Li), silicon (Si) and barium (Ba).

Further, the crystals may include carbon (C), oxygen (O), sodium (Na), silicon (Si), phosphorus (P), calcium (Ca), barium (Ba) and lithium (Li), and the crystals may be natural crystals, and the numerical value of each of the components constituting the crystals may coincide with the numerical value of each of the components constituting the remains.

Further, in the step of forming the spherical seeds, the natural mineral may be mixed in an amount of 9˜11 g per 9˜11 g of the bone powder.

Further, in the step of forming the spherical seeds, the spherical seeds may be formed by putting the mixture of the bone powder and the natural mineral into a molding board, and, in the step of calcinating the spherical seeds, the spherical seeds may be calcinated by disposing the molding board in a calcinatory to form the solid crystals.

### BRIEF DESCRIPTION OF THE DRAWINGS

The above and other object, features and advantages of the present invention will be more clearly understood from the following detailed description taken in conjunction with the accompanying drawing, in which:

FIG. 1 is a flowchart showing a method of making crystals from the remains according to an embodiment of the present invention.

### DESCRIPTION OF THE PREFERRED EMBODIMENTS

The present invention relates to a method of crystallizing the remains existing after cremating the body.

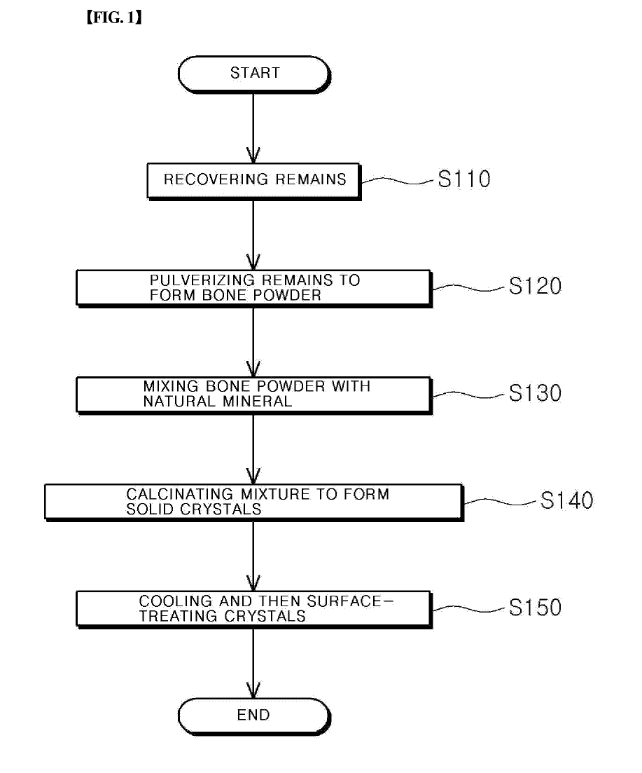

Hereinafter, a method of making crystals from the remains according to an embodiment of the present invention will be described in detail with reference to FIG. 1.

First, the remains are recovered (S110).

Subsequently, the remains are pulverized by a pulverizer to form bone powder having a particle size of 0.05 mm or less (S120).

Subsequently, the bone powder is mixed with a natural mineral to form spherical seeds (S130).

In this case, the natural mineral includes at least one selected from lithium (Li), silicon (Si) and barium (Ba).

The remains include phosphorus (P) and calcium (Ca). Meanwhile, the natural mineral serves to lower the melting point of phosphorus (P) and calcium (Ca) from 1600° C. to 900˜950° C. Therefore, at the time of calcinating the bone powder later, since the melting point of the bone powder is lowered, there is an advantage in that the bone powder may not be melted at very high temperature.

Here, when the natural mineral is mixed with the bone powder, the natural mineral is mixed in an amount of 9˜11 g (for example, 10 g) per 9˜11 g (for example, 10 g) of the bone powder.

Further, the mixture of the bone powder and the natural mineral is formed into the spherical seeds using a molding board. The molding board is provided with spherical recesses corresponding to the spherical seeds such that the spherical seeds can be easily formed. In addition to this method, the spherical seeds may be formed in a variety of other manners.

After the step (S130), the spherical seeds are put into a calcinator and then left at a temperature of 900˜950° C. for 10˜20 minutes to form solid crystals (S140). For example, in this step (S130), the molding board is disposed in the calcinator to calcinate the bone powder. According to this method, solid spherical crystals can be made.

Since the natural mineral is mixed with the bone powder in the previous step (S130), the melting point of the bone powder is lowered in the step (S140), so that the bone powder may not be melted at high temperature of 1200° C. or more, thereby reducing the time and cost for forming the crystals.

Here, the crystals include carbon (C), oxygen (O), sodium (Na), silicon (Si), phosphorus (P), calcium (Ca), barium (Ba), and lithium (Li). The crystals are natural crystals, and the numerical value of each of the components constituting the crystals coincides with the numerical values of each of the components constituting the remains.

Subsequently, the crystals are cooled and then surface-treated (S150). The cooling of the crystals may be conducted using a natural cooling method, but the present invention is not limited thereto. Further, the surface treatment of the crystals may be conducted using painting paper, glossy paper or the like.

As described above, the method of making crystals from the remains according to the present invention is advantageous in that the time and cost for forming crystals can be reduced by mixing bone powder with a natural mineral and then calcinating the mixture at lower temperature to form solid crystals.

Further, the crystals formed using the method of the present invention are advantageous in that they are easily stored and moved, and can contribute to the preservation of the natural environment and the improvement of funeral services, in that they can be kept in a sanitary manner compared to when the remains are kept in a cinerary urn in an unsanitary manner, and in that they can be efficiently used in terms of space utilization.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of making crystals from remains, comprising the steps of:
recovering remains;
pulverizing the remains to form bone powder having a particle size of 0.05 mm or less;
mixing the bone powder with a natural mineral to form spherical seeds;
putting the spherical seeds into a calcinator and then leaving them at a temperature of 900˜950° C. for 10˜20 minutes to form solid crystals; and
cooling and then surface-treating the solid crystals.

2. The method according to claim 1, wherein the natural mineral includes at least one selected from lithium (Li), silicon (Si) and barium (Ba).

3. The method according to claim 2 wherein the crystals include carbon (C), oxygen (O), sodium (Na), silicon (Si), phosphorus (P), calcium (Ca), barium (Ba) and lithium (Li), and the crystals are natural crystals, and the numerical value of each component constituting the crystals coincides with the numerical value of each component constituting the remains.

4. The method according to claim 1, wherein, in the step of forming the spherical seeds, the natural mineral is mixed in an amount of 9˜11 g per 9˜11 g of the bone powder.

5. The method according to claim 2, wherein, in the step of forming the spherical seeds, the natural mineral is mixed in an amount of 9˜11 g per 9˜11 g of the bone powder.

6. The method according to claim 4, wherein, in the step of forming the spherical seeds, the spherical seeds are formed by putting the mixture of the bone powder and the natural mineral into a molding board, and
wherein, in the step of calcinating the spherical seeds, the spherical seeds are calcinated by disposing the molding board in a calcinatory to form the solid crystals.

7. The method according to claim 5, wherein, in the step of forming the spherical seeds, the spherical seeds are formed by putting the mixture of the bone powder and the natural mineral into a molding board, and
wherein, in the step of calcinating the spherical seeds, the spherical seeds are calcinated by disposing the molding board in a calcinatory to form the solid crystals.
